(19) United States
(12) Patent Application Publication
(10) Pub. No.: US 2015/0199909 A1
(43) Pub. Date: Jul. 16, 2015

(54) CROSS-DIMENSIONAL LEARNING NETWORK

(71) Applicant: Perry M. Spagnola, Phoenix, AZ (US)

(72) Inventor: Perry M. Spagnola, Phoenix, AZ (US)

(21) Appl. No.: 14/154,050

(22) Filed: Jan. 13, 2014

(51) Int. Cl. G09B 5/08

(52) U.S. Cl. CPC G09B 5/08

(57) ABSTRACT

A method/apparatus/system for generation of a cross-dimensional learning network is described herein. The learning network contains a plurality of learning objects each made of an aggregation of learning content. The learning objects of the learning network are interconnected based on one or several skill levels embodied in the learning content of the learning objects. These skill levels can be based on the subject matter of the learning content and/or can be independent of the subject matter of the learning content. A new learning object can be placed within the learning network based on the skill level of the learning object.

### BACKGROUND OF THE INVENTION

This disclosure relates in general to on-line or computerized learning including, but without limitation to learning or instruction with a Learning Management System (LMS) and/or Online Homework System (OHS) and, but not by way of limitation, to assisting students using the LMS and/or OHS.

Numerous resources can be used in facilitating student achievement of an education goal. These resources can include, but not by way of limitation, instructional resources such as lectures, demonstrations, or example problems, practice resources such as practice problems or assignments, evaluation resources including, for example, a quiz, a test, or the like, and remediation resources. These resources are frequently provided according to a curriculum or syllabus. In particular, in the class-room environment, a syllabus identifies the resources that will be provided to a student and outlines the order in which resources will be provided to a student.

### SUMMARY OF THE INVENTION

In one embodiment, the present disclosure relates to a method of adding a learning object to a multi-dimensional network. The method includes identifying a first learning object that is an aggregation of learning content associated with an assessment, retrieving information associated with the first learning object, which information associated with the first learning object identifies an aspect of the first learning object, identifying a non-subject skill level of the first learning object, which non-subject skill level is an indicator of the non-subject difficulty of the content of the first learning object, and adding a value indicative of the non-subject skill value of the first learning object. The method includes identifying a second learning object that includes a non-subject skill level lower than the non-subject skill level of the first learning object, identifying a third learning object comprising a non-subject skill level higher than the non-subject skill level of the first learning object, and generating a second learning vector extending from the second learning object to the first learning object and a third learning vector extending from the first learning object to the third learning object.

In some embodiments of the method, the non-subject skill level is at least one of a quantile level and a lexile level. In some embodiments of the method, the aggregation of learning content includes a plurality of content objects and an assessment.

In some embodiments of the method, identifying the non-subject skill level of the first learning object includes determining if the first learning object has a corresponding non-subject skill level identified in the information associated with the first learning object, and in some embodiments, identifying the non-subject skill level of the first learning object can include determining a skill level of the first learning object if a non-subject skill level is not identified in the information associated with the first learning object. In some embodiments of the method, the non-subject skill level is determined by analyzing the aggregation of learning content of the learning object which can include analyzing one of the content objects or the assessment.

In some embodiments, the method can include determining a subject matter of the first learning object, and in some embodiments, determining the subject matter of the first learning object can include extracting information identifying the subject matter of the first learning object from the information associated with the first learning object. In some embodiments, at least one of the second and third learning objects can include the same subject matter as the first learning object.

In one embodiment, the preset disclosure relates to a system for maintaining a multi-dimensional network. The system can include memory including a plurality of learning objects that can include an aggregation of learning content associated with an assessment, and information associated with the learning objects, which information identifies an aspect of the therewith associated learning object. The system can include a processor that can identify a first learning object, identify a non-subject skill level of the first learning object, which non-subject skill level is an indicator of the non-subject difficulty of the content of the first learning object, add a value indicative of the non-subject skill value of the first learning object, identify a second learning object having a non-subject skill level lower than the non-subject skill level of the first learning object, identify a third learning object having a non-subject skill level higher than the non-subject skill level of the first learning object, and generate second learning vector extending from the second learning object to the first learning object and a third learning vector extending from the first learning object to the third learning object.

In some embodiments, the process can further retrieve information associated with the first learning object, which information identifies an aspect of the first learning object. In some embodiments of the system , the non-subject skill level includes at least one of a quantile level and a lexile level. In some embodiments of the system, the aggregation of learning content includes a plurality of content objects.

In one embodiment, the present disclosure relates to a method of generating a multidimensional learning object network. The method includes identifying a first learning object having a plurality of content objects. In some embodiments, the content objects are associated with an assessment, and the content object includes groupings of learning content. The method includes selecting a content object from the plurality of content objects, selecting a desired skill level determination, which desired skill level determination includes a determination of a skill-related degree of difficulty of the learning content of the content object, determining the skill level of the learning content of the content object, and retrieving assessment information associated with an assessment. In some embodiments, the assessment information identifies a skill evaluated by the assessment and the skill level evaluated by the assessment. The method includes determining if the assessment matches the learning content of the content object, and generating a learning vector connecting the content object and the assessment if the skill evaluated by the assessment and the skill level evaluated by the assessment match the determined skill and the determined skill level of the content object.

In some embodiments of the method, determining if the assessment matches the learning content of the content object includes determining if the skill evaluated by the assessment matches the skill of the determined skill level of the learning content of the content object, and in some embodiments, determining if the assessment matches the learning content of the content object includes determining if the skill level evaluated by the assessment matches the determined skill level of the learning content of the content object. .In some embodiments, determining the skill level of the learning content of the content object includes retrieving data associated with the content object and identifying the skill level of the learning content of the content object. In some embodiment of the method, determining the skill level of the learning content of the content object includes evaluating the learning content of the content object for skill level indicators. In some embodiments of the method, the skill level indicators are at least one of vocabulary and mathematical symbols.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 is a schematic illustration of one embodiment of a learning system.

FIG. 2 is a schematic illustration of one embodiment of a user device for use with the learning system.

FIG. 3 is a schematic illustration of one embodiment of a learning object network containing two indicated learning sequences.

FIG. 4 is a flowchart illustrating one embodiment of a process for associating a content object with an assessment.

FIG. 5 is a flowchart illustrating one embodiment of a process for placing a learning object within a learning object network.

FIG. 6 is a flowchart illustrating one embodiment of a process for generating a multidimensional learning object network.

FIG. 7 is a schematic illustration of one embodiment of the computer system.

FIG. 8 is a schematic illustration of one embodiment of a special-purpose computer system.

In the appended figures, similar components and/or features may have the same reference label. Where the reference label is used in the specification, the description is applicable to any one of the similar components having the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

In one embodiment the present disclosure relates to systems and methods for generating a multidimensional learning object network. In some embodiments, the multidimensional learning object network can be generated by identifying multiple levels and dimensions of connectivity between a first learning object and other learning objects in the learning object network. In some embodiments, and similar to connection of subject matter within a syllabus, a learning object can be connected to other learning objects in the learning object network based on a progression of subject matter within a subject. In such an embodiment, one subject topic is a prerequisite to one or several other subject topics. In addition to this connectivity of a learning object within a learning object network, additional dimensions of connectivity can be generated within a learning object network to create a multidimensional learning object network.

In some embodiments, the connectivity within a learning object network can be limited to one or several topics, subjects, courses of study, or the like, and in some embodiments, this connectivity can extend beyond one or several topics, subjects, courses of study, or the like. In one embodiment, for example, one or several learning objects, one or several content objects of the one or several learning objects and/or the topics of the one or several learning objects or of the one or several content objects associated with the one or several learning objects can be evaluated to identify a skill level of the same. In some embodiments, the skill level can be a subject independent skill level such as, for example, a lexile and/or quantile skill level. In some embodiments, the identified skill level can be used to find one or several learning objects, one or several content objects of the one or several learning objects, and/or topics of the one or several learning objects or of the one or several content objects associated with the one or several learning objects having a skill level that is either lower or higher than the skill level of the evaluated one or several learning objects, one or several content objects of the one or several learning objects, and/or the topics of the one or several learning objects or of the one or several content objects associated with the one or several learning objects.

In some embodiments, learning vectors can be established between the evaluated one or several learning objects, the one or several content objects of the one or several learning objects, and/or the topics of the one or several learning objects or of the one or several content objects associated with the one or several learning objects and the identified one or several learning objects, one or several content objects of the one or several learning object and/or the topics of the one or several learning objects or of the one or several content objects associated with the one or several learning objects. In some embodiments, these learning vectors can indicate the prerequisite relationship between the evaluated and the identified one or several learning objects, the one or several content objects of the one or several learning objects, and/or the topics of the one or several learning objects or of the one or several content objects associated with the one or several learning objects.

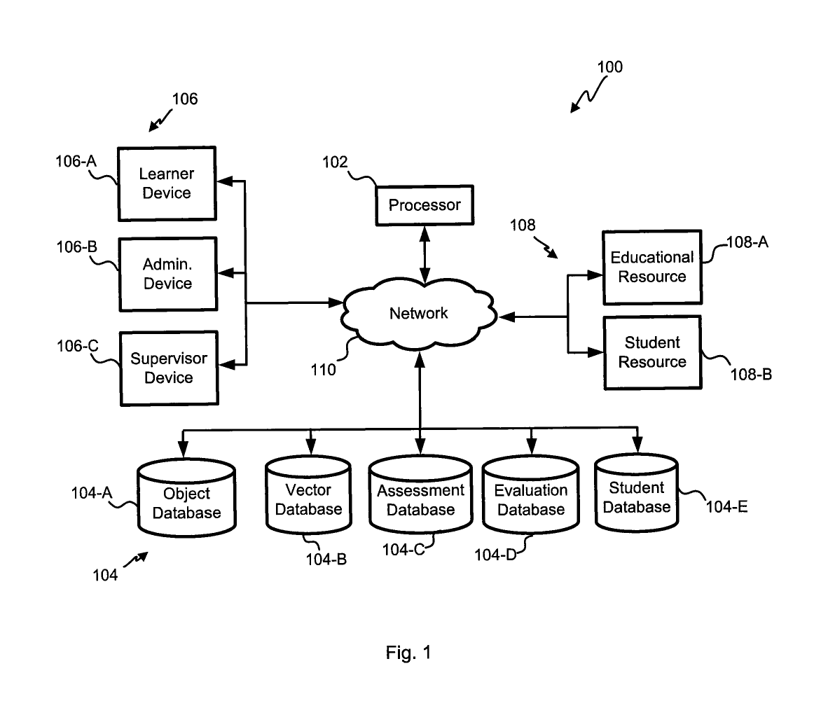

With reference now to FIG. 1, a block diagram of one embodiment of a learning system 100 is shown. The learning system 100 collects, receives, and stores data relating to the actions of one or several students within a learning object network. In some embodiments, the learning object network can include a plurality of learning objects that are linked in prerequisite relationships via a plurality of learning vectors. The learning system 100 utilizes this data to create, maintain, and update learning vectors connecting learning objects within the learning object network. In some embodiments, the learning vectors can be updated based on the success and/or failure of a student in traversing the learning vector, the context of the learning vector, and/or the student context. In some embodiments, the learning vector context can be the aggregated information relating to the learning vector. This can include identification of the prerequisite relationship between the learning objects directly connected by the learning vector, the magnitude of the learning vector, the strength of the learning vector, and/or any other desired parameter of the learning vector. In some embodiments, the strength of the learning vector context can vary based on the student context. Thus, in some embodiments, the strength and/or magnitude of the learning vector can vary with respect to different student contexts. Thus, some student contexts may correspond to an increased strength and/or magnitude of the learning vector whereas other student contexts may correspond to a decreased strength and/or magnitude of the learning vector.

The learning system 100 can include a processor 102. The processor 102 can provide instructions to, and receive information from the other components of the learning system 100. The processor 102 can act according to stored instructions, which stored instructions can be located in memory associated with the processor and/or in other components of the learning system 100. The processor 102 can be a microprocessor, such as a microprocessor from Intel® or Advanced Micro Devices, Inc.®, or the like.

The learning system 100 can include one or several databases 104. The one or several databases 104 can comprise stored data relevant to the functions of the learning system 100. The one or several databases 104 can include an object database 104-A. The object database 104-A can include data relating to one or several learning objects. In some embodiments, a learning object can be an aggregation of learning content that can be, for example, associated with an assessment such as, for example, a test, quiz, one or several practice problems or questions, homework, or the like. The object database 104-A can, in some embodiments, include the learning objects, including any subcomponents of the learning objects such as, for example, one or several content objects containing instructional material, and specifically comprising a presentation of learning material and/or one or several assessment objects which can comprise a content object that includes features configured to assess the learning and/or mastery of the subject matter of one or several content objects by the student. In some embodiments, the learning object can include an initial content object and/or assessment object, one or several intermediate content objects and/or assessment objects, and one or several terminal content objects and/or assessment objects. In one embodiment, the terminal assessment object can assess the student's mastery of the content contained in some or all of the content objects within the learning object.

The object database 104-A can include information to allow customization of the student learning experience. In one embodiment, for example, the object database 104-A can include threshold data that can be used in connection with student results to determine if a student is meeting expectations, exceeding expectations, far exceeding expectations, failing to meet expectations, or providing completely unsatisfactory results. In some embodiments, the object database 104-A can include thresholds that can be used to trigger the providing of learning objects to the student, which learning objects are not included in the selected learning path. In one embodiment, the object database 104-A can include one or several enhancement thresholds, and in some embodiments, the object database 104-A can include one or several remediation thresholds. In some embodiments, these learning objects can be one or several enhancement objects for a student who is exceeding and/or far exceeding expectations, and in some embodiments the learning objects can be one or several remedial objects for a student who is not meeting expectations.

The one or several databases 104 can include a vector database 104-B. The vector database 104-B can include information relating to one or several learning vectors. In some embodiments, and as discussed above, the learning object network can contain a plurality of learning objects. These objects can be connected via a plurality of learning vectors. A learning vector can connect a first learning object to a second learning object and can indicate a prerequisite relationship between the first and second learning objects, which prerequisite relationship can indicate the temporal order in which the first and second learning objects should be completed and/or attempted. In some embodiments, the first learning object, which is a prerequisite to the second learning object within the set defined by the first and second learning objects connected within a prerequisite relationship by the learning vector, can be identified as the incident learning object (LO_{I}), and the second learning object can be identified as the terminal learning object (LO_{T}).

In some embodiments, the vector database 104-B can include information relating to a variety of parameters of the learning vector. In some embodiments, this can include, for example, the strength of the learning vector, which strength can indicate the effectiveness of the learning vector and/or the degree to which students successfully traverse the learning vector and complete the learning object, the magnitude of the learning vector, which magnitude can provide an indicator of the rate at which one or several students have traversed and/or are expected to traverse the learning vector, a learning vector context including, for example, information identifying the strength and/or magnitude of the learning vector for one or several student contexts, or the like.

The learning system 100 can include an assessment database 104-C. The assessment database 104-C can include information identifying the connection and/or connections between learning objects within the learning object network. In some embodiments, the assessment database 104-C can include information relating to multidimensional linking between one or several learning objects. In some embodiments, the multiple dimensions of the learning object network can be the subject matter of the learning object network, skills that are relevant to the completion and/or comprehension of the subject matter of the learning object network skills but that are not the object of the learning object network such as, for example, reading (lexile) skills and math (quantile) skills. In some embodiments, information contained within the assessment database 104-C can be used in placing the learning objects within the learning object network and/or in connecting new learning objects with other objects within the learning object network.

The learning system 100 can include an evaluation database 104-D. The evaluation database 104-D can include information used in evaluating the effectiveness of one or several learning objects, one or several learning sequences, one or several content objects, one or several assessment objects, and/or the like. In some embodiments, for example, this information can include one or several effectiveness thresholds which can define the boundary between satisfactory results associated with one or several of the above and unsatisfactory results associated with one or several of the above.

The learning system 100 can include a student database 106-E. The student database 106-E can include information relating to one or several students including, for example, student contexts for one or several students. In some embodiments, a student context can contain information relating to past learning completed by the associated student, objectives of the student, which objectives can be the learning goals of the student including, for example, the achievement of a desired or specified position within the learning object network, and/or the learning style of the student. In some embodiments, the information contained within student database 106-E can be updated based on the results of interactions between the student and the learning object network. In some embodiments, and based on continual updates to the student context, information contained within the student database 106-E can be biased for temporal significance in that a biasing function can be applied to information contained within the student database to place greater weight on recently collected data. In some embodiments, the temporal biasing function can advantageously allow recently collected data to more significantly affect the student context than older, and potentially stale data relating to the student.

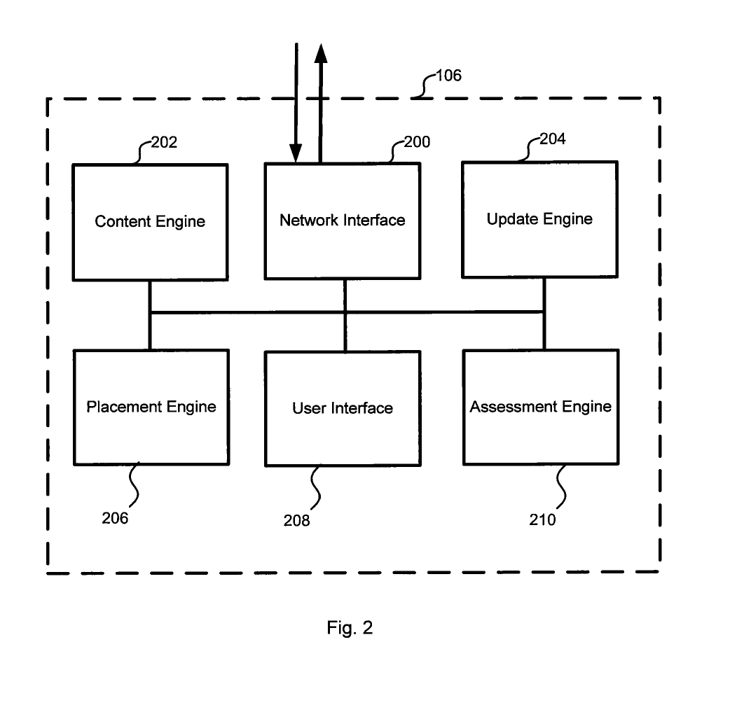

The learning system 100 can include one or several user devices 106, which can include, a student device 106-A, an administrator device 106-B, and/or a supervisor device 106-C. The user devices 106 allow a user, including a student that can be a learner, an evaluator, a supervisor, a trainer, and/or a trainee to access the learning system 100. The details and function of the user devices 106 will be discussed at greater length in reference to FIG. 2 below.

The learning system 100 can include a data source 108. The data source 108 can be the source of the one or several learning objects, content objects, assessment objects, or the like, and can be the source of some or all of the student information stored within the student database 104-D. In some embodiments, the data source 108 can include, for example, an educational resource 108-A and a student resource 108-B. In some embodiments, the educational resource 108-A can include a Learning Management System (LMS), an educational institution, a training institution, or the like, and a student resource 108-B can include, for example, any source of information relating to the student and/or pass student performance.

The learning system 100 can include a network 110. The network 110 allows communication between the components of the learning system 100. The network 110 can be, for example, a local area network (LAN), a wide area network (WAN), a wired network, wireless network, a telephone network such as, for example, a cellphone network, the Internet, the World Wide Web, or any other desired network. In some embodiments, the network 110 can use any desired communication and/or network protocols.

With reference now to FIG. 2, a block diagram of one embodiment of a user device 106 is shown. As discussed above, the user device 106 can be configured to provide information to and/or receive information from other components of the learning system 100. The user device can access the learning system 100 through any desired means or technology, including, for example, a webpage, a web portal, or via network 110. As depicted in FIG. 2, the user device 106 can include a network interface 200. The network interface 200 allows the user device 106 to access the other components of the learning system 100, and specifically allows the user device 106 to access the network 110 of the learning system 100. The network interface 200 can include features configured to send and receive information, including, for example, an antenna, a modem, a transmitter, receiver, or any other feature that can send and receive information. The network interface 200 can communicate via telephone, cable, fiber-optic, or any other wired communication network. In some embodiments, the network interface 200 can communicate via cellular networks, WLAN networks, or any other wireless network.

The user device 106 can include a content engine 202. The content engine 202 can receive one or several learning objects and/or content objects from the object database 104-A, and can communicate them to the user via the user interface of the user device 106.

The user device 106 can include an update engine 204. In some embodiments, the update engine 204 can be configured to receive information relating to the traversal of one or several learning vectors and update the learning vectors based on the student experience associated with the terminal learning object of the one or several learning vectors. In some embodiments, the update engine 204 can be configured to update the learning vector according to the student context and/or the context of the learning vector. In some embodiments, this can include updating the learning vector according to one or several learning styles. In some embodiments, the update engine 204 can receive information from, and/or provide information to the vector database 104-B.

The user device 106 can include a placement engine 206. The placement engine 206 can be configured to place one or several learning objects within the learning object network. Specifically, in some embodiments, the placement engine can be configured to identify prerequisite relationships for a new learning object. In some embodiments, these prerequisite relationships can be within the subject matter of the learning object in some embodiments, these prerequisite relationships can be outside of the subject matter of the learning object. In some embodiments, the placement engine 206 can receive information from, and/or send information to the assessment database 104-C.

The user device 106 can include a user interface 208 that communicates information to, and receives inputs from a user. The user interface 208 can include a screen, a speaker, a monitor, a keyboard, a microphone, a mouse, a touchpad, a keypad, or any other feature or features that can receive inputs from a user and provide information to a user.

The user device 106 can include an assessment engine 210. The assessment engine can be configured to assess the effectiveness of one or several items within the learning object network including, for example, one or several learning objects, one or several learning sequences, and/or one or several content objects. In some embodiments, the assessment engine 210 can assess the contents of the learning object network in connection with information stored within the evaluation database 104-D. In some embodiments, the assessment engine 210 can send information to, and/or receive information from the evaluation database 104-D.

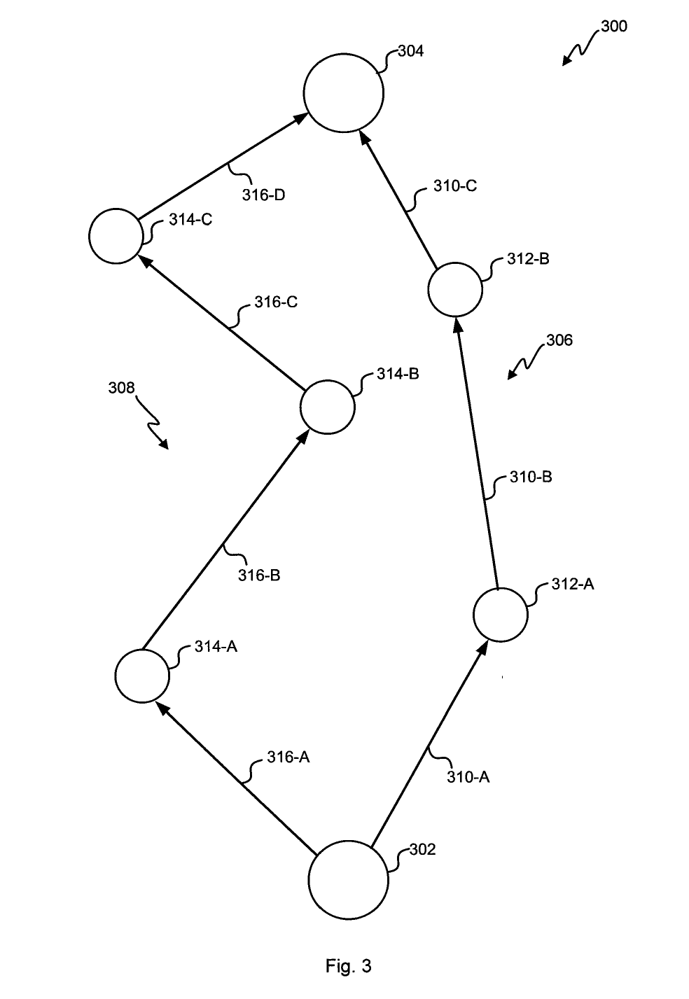

With reference now to FIG. 3, a schematic illustration of one embodiment of the learning object network 300 is shown. In some embodiments, the learning object network 300 can comprise a plurality of learning objects connected via a plurality of learning vectors. In the embodiment depicted in FIG. 3, the learning object network 300 includes a starting learning object 302 and a destination learning object 304. As seen in FIG. 3, the starting learning object 302 and the destination learning object 304 are connected by a first learning sequence 306 and the second learning sequence 308. The first learning sequence 306 comprises learning objects 312-A and 312-B which are connected with each other and with both of the starting learning object 302 and the destination learning object 304 via learning vectors 310-A, 310-B, and 310-C. Similarly, the second learning sequence 308 comprises learning objects 314-A, 314-B, and 314 C, which are connected with each other and with both of the starting learning object 302 and the destination learning object 304 via learning vectors 316-A, 316-B, 316-C, and 316-D. As seen in FIG. 3, the magnitude of the learning vectors 310-A, 310-B, 310-C, 316-A, 316-B, 316-C, 316-D is not constant and some of the learning vectors 310-A, 310-B, 310-C, 316-A, 316-B, 316-C, 316-D have a greater magnitude than others of the learning vectors 310-A, 310-B, 310-C, 316-A, 316-B, 316-C, 316-D, and some of the learning vectors 310-A, 310-B, 310-C, 316-A, 316-B, 316-C, 316-D have a lesser magnitude than others of the learning vectors 310-A, 310-B, 310-C, 316-A, 316-B, 316-C, 316-D. Similarly, the aggregate magnitude of the first learning sequence 306, which aggregate magnitude is the sum of the magnitudes of the learning vectors 310-A, 310-B, 310-C in the first learning sequence 306, is less than the aggregate magnitude of the second learning sequence 308, which aggregate magnitude is the sum of the magnitudes of the learning vectors 316-A, 316-B, 316-C, 316-D in the second learning sequence 308. In some embodiments, the magnitude of the learning vectors 310-A, 310-B, 310-C, 316-A, 316-B, 316-C, 316-D and/or the magnitude of the learning sequence 306, 308 can correspond to the length of time required to complete a learning vector 310-A, 310-B, 310-C, 316-A, 316-B, 316-C, 316-D and/or a learning sequence 306, 308, by the effectiveness and teaching mastery of the subject matter of the same.

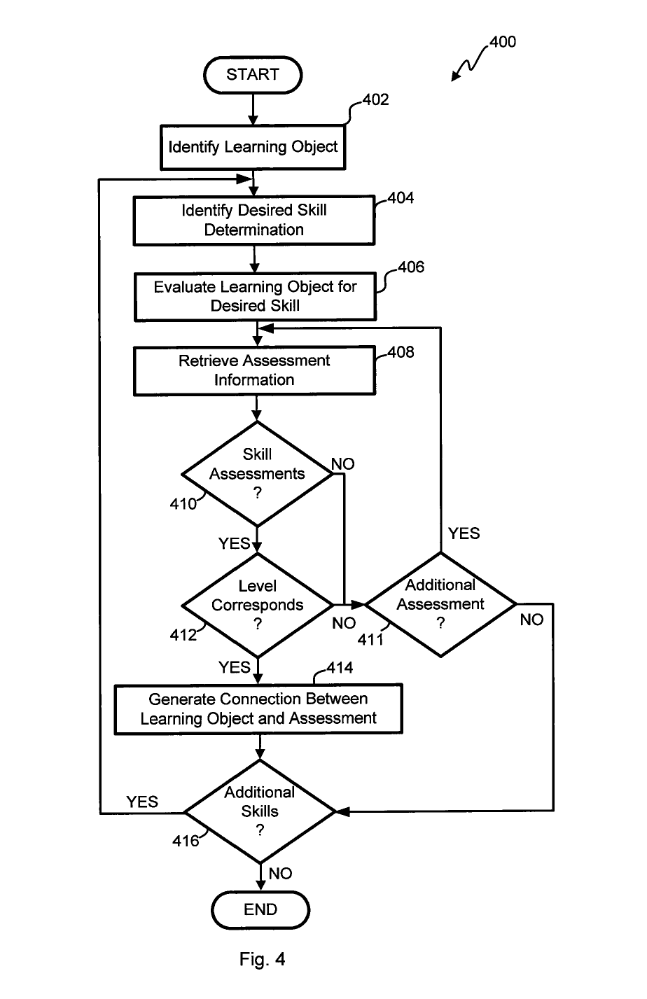

With reference now to FIG. 4, a flowchart illustrating one embodiment of a process 400 for associating a learning content, such as contained by a content object with an assessment is shown. In some embodiments, the process 400 can be performed when a new learning object is added to the learning object network, or with learning objects already within the learning object network. The process 400 can be performed by the learning system 100 and/or one or several components thereof. The process 400 begins at block 402 wherein a learning object and/or content object in the learning object is identified. In some embodiments, the identified learning object can be a learning object that is being added to the learning object network, a learning object that has been recently added to the learning object network, and/or a learning object that is already within the learning object network. In some embodiments, the learning object can be identified by retrieving information from one of the databases 104 such as the object database 104-A. In one such embodiment, the object database 104-A can contain information indicating whether the process 400 has been performed on any, some, or all of the learning objects in the learning object network. This information can be analyzed to identify a subset of the learning objects for which process 400 has not been performed. From the subset, one or several of the learning objects can be selected, and after completion of process 400, the information indicating whether the process 400 has been performed on the one or several selected learning objects can be updated.

In some embodiments, and as part of block 402, portions of the learning content of one or several of the learning objects can be selected. In one such embodiment, for example, one or several content objects within the one or several learning objects can be selected for evaluation. In this embodiment, the one or several content objects can be selected via similar process to that used in selecting the learning objects, and specifically by identifying a subset of the content objects for which process 400 has not been completed and selecting one or several of the content objects from the identified subset of the content objects.

After the learning object has been identified, the process 400 proceeds to block 404 wherein a desired skill determination is identified. In some embodiments, for example, one or several analyses can be performed on a learning object to evaluate the learning object for one or several skill levels. In some embodiments, the skill level can relate to the subject matter of the learning object, and in some embodiments, the skill level can be a non-subject skill level that does not relate to the subject of the learning object. In some embodiments, skill levels can include a quantile skill level, a lexile skill level, or the like. In some embodiments, one of the databases 104, such as the object database 104-A can include information indicating analyses that have been performed on the identified learning object. In some embodiments, this information can include information indicating whether a skill level has been identified for the learning object. In such an embodiment, the process 400 can include retrieving this information from the one of the databases 104 and identifying a subset of analyses that have not been performed on the identified learning object and/or skill levels that have not been identified for the identified learning object. In one embodiment, one or several desired skill determinations can be selected from the subset of analyses that have not been performed on the identified learning object and/or skill levels that have not been identified for the identified learning object. In such an embodiment, this information can be updated upon the completion of process 400.

After the desired skill determination has been identified, the process 400 proceeds to block 406 wherein the learning object is evaluated for the desired skill level. In some embodiments, this evaluation can be performed by the processor 102 and/or other component of the learning system 100. In some embodiments, for example, this evaluation of the learning object can include retrieving data associated with the learning object and/or content object and identifying the skill level of the learning content of the learning object and/or of the content object from the retrieved data. In some embodiments, this evaluation can include an evaluation of the learning content of the learning object and/or of the content object for skill level indicators. These skill level indicators can be any feature that indicates a skill level and can include, for example, word usage, vocabulary, mathematical and/or scientific symbols, sentence structure, used grammatical rules, and/or the like. In some embodiments, the existence of one or several of these skill level indicators can correspond to a skill level and in some embodiments, the existence of certain skill level indicators can correspond to a first skill level and the existence of second and/or first and second skill level indicators can correspond to a second skill level. In some embodiments, the learning object and/or content object is evaluated for the desired skill by identifying one or several skill level indicators within the learning content of the learning object and/or of the content object and correlating the identified skill level indicators to a skill level.

After the learning object has been evaluated for the desired skill, the process 400 proceeds block 408 wherein assessment information is retrieved. In some embodiments, the assessment information can be associated with an assessment and can identify attributes of the assessment. In some embodiments, the assessment information can be stored within one of the databases 104 such as, for example, the assessment database 104-C. In one embodiment, for example, the assessment information can identify a skill evaluated by the assessment and a skill level of the assessment.

After the assessment information has been retrieved, the process 400 proceeds to decision state 410 wherein it is determined if the skill evaluated by the assessment corresponds to the desired skill. In some embodiments, this determination can be made by the processor 102 by retrieving information indicating the desired skill and extracting information identifying the skill evaluated by the assessment from the assessment information. The information indicating the desired skill can be compared to the information identifying the skill evaluated by the assessment to determine if both the desired skill and the skill evaluated by the assessment are the same.

If it is determined that the assessment evaluates a different skill than the desired skill, then the process 400 proceeds to decision state 411 and determines if there are additional assessments. In some embodiments, this can include querying one the databases 104, such as the assessment database 104-C for information regarding assessments. In some embodiments, this information can identify whether some or all of the assessments have been evaluated for correspondence to the learning content currently the subject of process 400. If it is determined that there are additional assessments, then the process 400 returns to block 408 wherein assessment information for additional assessments is retrieved.

Returning again to decision state 410, if it is determined that the assessment evaluates the same skill as the desired skill, then the process 400 proceeds to decision state 412 wherein it is determined if the skill level of the assessment matches the skill level of the learning content of the learning object and/or of the content object. In some embodiments, this can include a comparison of the determined skill level of learning content of the content object and/or of the learning object and the skill level identified within the assessment information. In some embodiments, this comparison can be performed by the processor 102.

If it is determined that the skill level evaluated by the assessment does not match the skill level of the learning content of the learning object and/or of the content object a different skill than the desired skill, then the process 400 proceeds to decision state 411 and determines if there are additional assessments. In some embodiments, this can include querying one the databases 104, such as the assessment database 104-C for information regarding assessments. In some embodiments, this information can identify whether some or all of the assessments have been evaluated for correspondence to the learning content currently the subject of process 400. If it is determined that there are additional assessments, then the process 400 returns to block 408 wherein assessment information for additional assessments is retrieved.

Returning again to decision state 412, if it is determined that the skill levels of the assessment and of learning content correspond, then the process 400 proceeds block 414 wherein a connection between the learning content and the assessment is generated. In some embodiments, this connection can be stored in one of the databases 104 such as, for example, the object database 104-A and/or the assessment database 104-C. In some embodiments, and as part of block 414, connections between evaluated learning content in the learning object and/or the content objects can be connected with other learning content contained within other learning objects and/or other content objects within the learning object network. The details of the generation of connections throughout the learning object network will be discussed at greater length below.

After the connection between the learning content and the assessment has been generated, or returning again to decision state 411 if it is determined that there are no additional assessments, then the process 400 proceeds to decision state 416 wherein it is determined whether to perform additional skill level evaluations on the learning content of the learning object and/or the content object. In some embodiment, this determination can be made by identifying whether the learning content has been evaluated for all of a desired set of skills. If the learning content has not been evaluated for all of the desired set of skills, then the process 400 returns to decision state 404. If the learning content has been evaluated for all of the desired set of skills, then the process 400 terminates or continues with other steps.

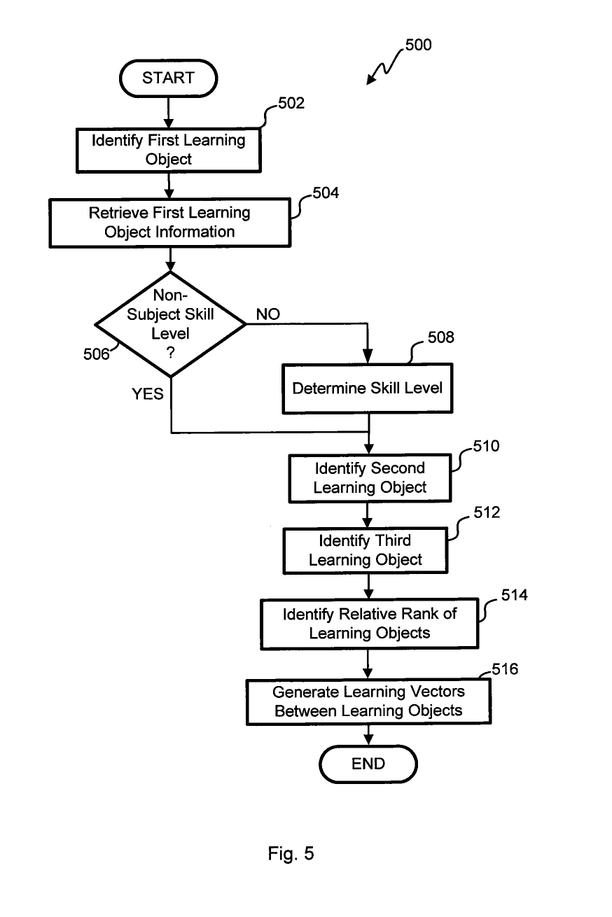

With reference now to FIG. 5, a flowchart illustrating one embodiment of a process 500 for placing learning content such as contained within a learning object or a content object within a learning object network is shown. As the process 500 relates to learning content in both learning objects and in content objects, following references to learning objects broadly encompass learning content contained within learning objects and/or content objects. In some embodiments, the process 500 can be performed when a new learning object is added to the learning object network. The process 500 can be performed by the learning system 100 and/or one or several components thereof. The process 500 begins at block 502 wherein a first learning object is identified. In some embodiments, the first learning object can be the learning object that is being added to the learning object network. The first learning object can be stored within one of the databases 104 including, for example, the object database 104-A, and can be identified by accessing information from the same.

After the first learning object has been identified, the process 500 proceeds to block 504 wherein first learning object information is retrieved. In some embodiments, the first learning object information can include metadata providing information relating to the content of the first learning object such as, for example, metadata identifying aspects of the content objects composing the first learning object. In some embodiments, the first learning object information can be associated with the learning object in one of the databases 104 such as, for example, the object database 104-A.

After the first learning object information has been retrieved, the process 500 proceeds to decision state 506 wherein it is determined if a subject independent skill level, also referred to herein as a non-subject skill level, is associated with the first learning object. In some embodiments, the non-subject skill level is independent of the subject matter of the learning object and relates instead to, for example, one or more student skills such as a lexile skill level, a quantile skill level, or the like. In some embodiments, the subject independent skill level can be identified in the metadata associated with the learning object retrieved in block 504. In such an embodiment, the metadata associated with the learning object can comprise one or several values identifying the subject independent skill level of the learning object such as, for example, a value identifying the lexile level associated with the learning object and/or the quantile level associated with the learning object.

If it is determined that the first learning object is not associated with a subject independent skill level, then the process proceeds to block 508 wherein the subject independent skill level is determined. In some embodiments, this determination can be made by the processor 102 and/or other component of the learning system 100. In one embodiment, for example, substantive analysis of the content of the learning object can be performed to determine the subject independent skill level of the learning object. In one embodiment, for example, this analysis can comprise lexile analysis, and in some embodiments, this analysis can comprise quantile analysis. In some embodiments, the determination of the subject independent skill level of the learning object can include storing a value associated with the learning object and indicative of the subject independent skill value of the learning object in one of the databases 104 such as, for example, the object database 104-A.

After the skill level has been determined or, returning to decision state 506 if it is determined that the learning object is associated with the subject independent skill level, the process 500 proceeds to block 510 wherein a second learning object is identified. In some embodiments, the second learning object comprises one of the learning objects stored within one of the databases 104 such as the object database 104-A, and the second learning object can be associated with metadata including a value indicative of the subject independent skill level of the second learning object. In some embodiments, the subject independent skill level of the second learning object can be one increment higher and/or one decrement lower than the subject independent skill level of the first learning object. In some embodiments, the second learning object can be identified by the processor 102 or by another component of the learning system 100.

After the second learning object has been identified, the process 500 proceeds to block 512 wherein a third learning object is identified. In some embodiments, the third learning object comprises one of the learning objects stored within one of the databases 104 such as the object database 104-A, and the third learning object can be associated with metadata including a value indicative of the subject independent skill level of the third learning object. In some embodiments, the subject independent skill level of the third learning object can be one increment higher and/or one decrement lower than the subject independent skill level of the first learning object. In some embodiments, the third learning object can be identified by the processor 102, or by another component of the learning system 100.

After the third learning object has been identified, the process proceeds to block 514 wherein the relative rank of the learning objects is identified. In some embodiments, this can include retrieving values identifying the subject independent skill level of the learning objects from one of the databases 104 such as the object database 104-A, and comparing those values identifying the subject independent skill level of the learning objects. In some embodiments, this relative ranking of the learning objects can be performed by the processor 102 and/or by another component of the learning system 100.

After the relative rank of the learning objects has been identified, the process 500 proceeds to block 516 wherein learning vectors between the three learning objects are generated. In some embodiments, the learning vectors between the three learning objects are generated to reflect the incrementing subject independent skill level, starting with the learning object having the lowest subject independent skill level. In some embodiments, for example, the learning object having the lowest subject independent skill level can be connected by a learning vector to the learning object having a higher subject independent skill level, and that learning object can be connected via a learning vector to the learning object having the highest subject independent skill level. In some embodiments, learning vectors connecting the learning objects can identify a prerequisite relationship so as to enable identification of which learning object is a subject independent skill level that is prerequisite to the next learning object. Advantageously, the generation of such learning vectors allows placement of a new learning object within the learning object network.

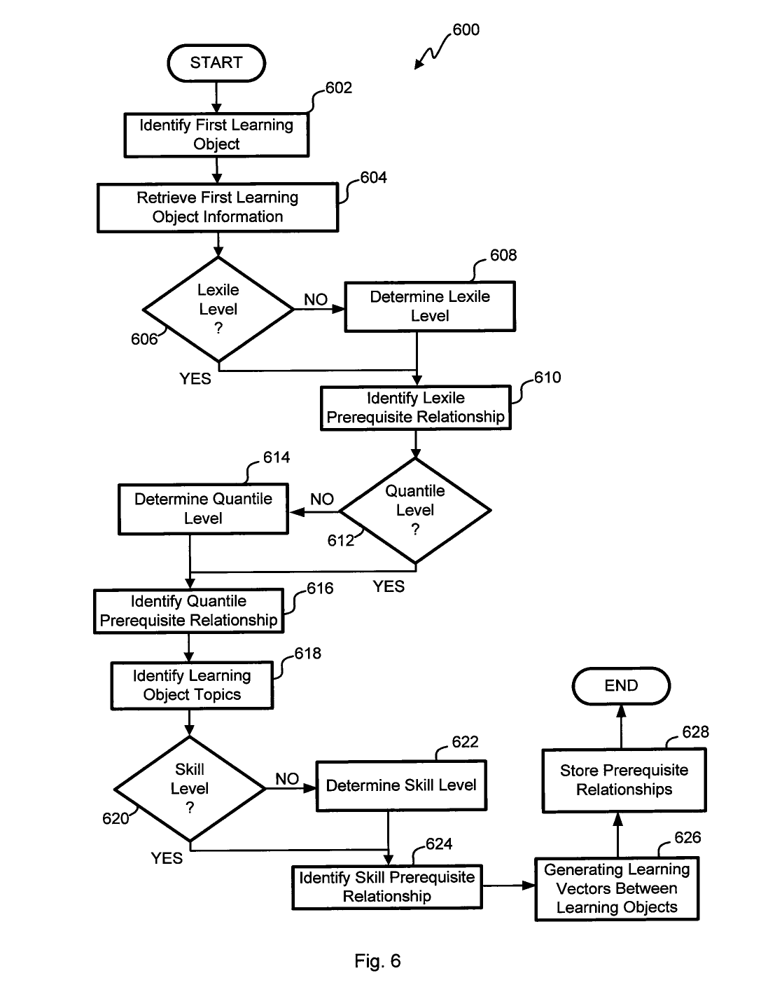

With reference now to FIG. 6, a flowchart illustrating one embodiment of a process 600 for generating a multidimensional learning object network is shown. . In some embodiments, the process 600 can be performed as an alternative to process 500 shown in FIG. 5, and in some embodiments, the steps of process 600 and process 500 can be intermixed. The process 600 specifically relates to a process for generating a multidimensional learning content network that can connect learning content contained within one or several learning objects and/or content objects. As the process 600 relates to learning content contained in both learning objects and/or content objects, the following references to learning objects broadly encompass content objects.

In some embodiments, the process 600 can be performed as an alternative to process 500 shown in FIG. 5, and in some embodiments, the steps of process 600 and process 500 can be intermixed. In some embodiments, process 600 can be performed as part of adding a learning object to the learning object network. The process 600 can be performed by the learning system 100 and/or one or several components thereof. The process 600 begins at block 602 wherein a first learning object is identified. In some embodiments, the first learning object can be the learning object that is being added to the learning object network. In some embodiments, the first learning object can be identified with information stored within one of the databases 104 including, for example, the object database 104-A.

After the first learning object has been identified, the process 600 proceeds to block 604 wherein first learning object information is retrieved. In some embodiments, the first learning object information can include metadata providing information relating to the content of the first learning object such as, for example, metadata identifying aspects of the content objects composing the first learning object. In some embodiments, the first learning object information can be associated with the learning object in one of the databases 104 such as, for example, the object database 104-A.

After the first learning object information has been retrieved, the process 600 proceeds to decision state 606 wherein it is determined if a lexile level is associated with the first learning object. In some embodiments, the lexile level is independent of the subject matter of the learning object and relates instead to the generic lexile level of the learning object. In some embodiments, the lexile level can be identified in the metadata associated with the learning object retrieved in block 606. In such an embodiment, the metadata associated with the learning object can comprise one or several values identifying the lexile level of the learning object.

If it is determined that the first learning object is not associated with a lexile level, then the process proceeds to block 608 wherein the lexile level is determined. In some embodiments, this determination can be made by the processor 102 and/or other components of the learning system 100. In one embodiment, for example, substantive analysis of the content of the learning object can be performed to determine the lexile level of the learning object. In one embodiment, for example, this analysis can be lexile analysis. In some embodiments, the determination of lexile level of the learning object can include storing a value associated with the learning object and indicative of the lexile level of the learning object in one of the databases 104 such as, for example, the object database 104-A.

After the lexile level has been determined or, returning to decision state 606 if it is determined that the learning object is associated with a lexile level, the process 600 proceeds to block 610 wherein the lexile prerequisite relationship is identified. In some embodiments, the identification of the lexile prerequisite relationship can include identifying one or several learning objects having a lexile level that is one decrement less than the lexile level of the first learning object and identify one or several learning objects having a lexile level that is one increment greater than the lexile level of the first learning object. In some embodiments, this identification can be made based on metadata stored within one of the databases 104 and specifically the object database 104-A. In one particular embodiment, metadata including values identifying lexile levels of one or several learning objects is retrieved from the object database 104-A, and the values identifying the lexile level of the one or several learning objects are compared to identify prerequisite relationships between the first learning object and one or several other learning objects. In some embodiments, this identification can be performed by the processor 102 and/or another component of the learning system 100.

After the lexile prerequisite relationship has been identified, the process 600 proceeds to decision state 612 wherein it is determined if a quantile level is associated with the first learning object. In some embodiments, the quantile level is independent of the subject matter of the learning object and relates instead to the generic quantile level of the learning object. In some embodiments, the quantile level can be identified in the metadata associated with the learning object retrieved in block 606. In such an embodiment, the metadata associated with the learning object can comprise one or several values identifying the quantile level of the learning object.

If it is determined that the first learning object is not associated with a quantile level, then the process 600 proceeds to block 614 wherein the quantile level is determined. In some embodiments, this determination can be made by the processor 102 and/or other components of the learning system 100. In one embodiment, for example, substantive analysis of the content of the learning object can be performed to determine the quantile level of the learning object. In one embodiment, for example, this analysis can be quantile analysis. In some embodiments, the determination of the quantile level of the learning object can include storing a value associated with the learning object and indicative of the quantile level of the learning object in one of the databases 104 such as, for example, the object database 104-A.

After the quantile level has been determined or, returning to decision state 612 if it is determined that the learning object is associated with a quantile level, the process 600 proceeds to block 616 wherein the quantile prerequisite relationship is identified. In some embodiments, the identification of the quantile prerequisite relationships can include identifying one or several learning objects having a quantile level that is one decrement less than the quantile level of the first learning object and identify one or several learning objects having a quantile level that is one increment greater than the quantile level of the first learning object. In some embodiments, this identification can be made based on metadata stored within one of the databases 104 and specifically in the object database 104-A. In one particular embodiment, metadata including values identifying quantile levels of one or several learning objects is retrieved from the object database 104-A, and the values identifying the quantile level of the one or several learning objects are compared to identify prerequisite relationships between the first learning object and one or several other learning objects. In some embodiments, this identification can be performed by the processor 102 and/or another component of the learning system 100.

After the quantile prerequisite relationship has been identified, the process 600 proceeds to block 618 wherein learning object topics are identified. In some embodiments, and as discussed above, the learning object can include a plurality of content objects and an assessment associated with the content objects. In such an embodiment, each of the content objects can represent a different topic within the learning object and/or some or all of the content objects can represent a plurality of topics. In such an embodiment, the process 600 can identify some or all of the plurality of topics associated with the learning object. This identification can be done by the processor's 102 analysis of metadata associated with the learning object that can be retrieved from one of the databases 104 such as the object database 104-A.

After the learning object topics have been identified, the process 600 proceeds to decision state 620 wherein it is determined if a skill level is associated with some or all of the topics of the first learning object. In some embodiments, a skill level can be one or both of the quantile level and the lexile level, and in some embodiments, the skill level can include other subject related and/or subject independent skill metrics. In some embodiments, the skill level can be identified in the metadata associated with the learning object retrieved in block 618. In such an embodiment, the metadata associated with the learning object can comprise one or several values identifying the skill level of some or all of the topics of the learning object.

If it is determined that the evaluated topic of the first learning object is not associated with a skill level, then the process 600 proceeds to block 622 wherein the skill level is determined. In some embodiments, this determination can be made by the processor 102 and/or other components of the learning system 100. In one embodiment, for example, substantive analysis of the evaluated topic of the learning object can be performed to determine the skill level of the evaluated topic of the learning object. In one embodiment, for example, this analysis can be quantile analysis, lexile analysis, or analysis associated with any other subject related and/or subject independent skill level. In some embodiments, the determination of the skill level of the evaluated topic of the learning object can include storing a value associated with the evaluated topic of the learning object and indicative of the skill level of the evaluated topic of the learning object in one of the databases 104 such as, for example, the object database 104-A.

After the skill level of the evaluated topic has been determined or, returning to decision state 620 if it is determined that some of the of the topics of the learning object are associated with a known skill level, the process 600 proceeds to block 624 wherein the skill prerequisite relationship is identified. In some embodiments, the identification of the skill prerequisite relationships can include identifying one or several learning objects and/or topics of learning objects having a skill level that is one decrement less than the skill level of the one or several evaluated topics of the first learning object and/or identify one or several learning objects and/or topics of learning objects having a skill level that is one increment greater than the skill level of the one or several evaluated topics of the first learning object. In some embodiments, this identification can be made based on metadata stored within one of the databases 104 and specifically the object database 104-A. In one particular embodiment, metadata including values identifying skill levels of one or several learning objects and/or of one or several topics associated with learning objects is retrieved from the object database 104-A, and the values identifying the skill level of the one or several learning objects and/or of the one or several topics associated with the learning objects are compared to identify prerequisite relationships between the one or several topics of the first learning object and one or several other learning objects and/or one or several topics of one or several other learning objects. In some embodiments, this identification can be performed by the processor 102 and/or other component of the learning system 100.

After the skill prerequisite relationship has been identified, the process 600 proceeds to block 626 wherein learning vectors between the identified learning objects and/or the identified topics of learning objects are generated. In some embodiments, the learning vectors are generated to reflect the identified prerequisite relationships and to indicate the relationship of the identified skill levels of the learning objects and/or the topics associated with the learning objects. Advantageously, the generating of such learning vectors allows placement of a new learning object within the learning object network and the movement of a student between learning objects to remediate and/or supplement a student learning experience. After the learning vectors have been generated, the process 600 proceeds to block 628, wherein the prerequisite relationships and the generated learning vectors are stored. In some embodiments, these prerequisite relationships and generated learning vectors can be associated with the learning objects and/or the learning object topics to which they relate, and can be stored in one of the databases 104 such as, for example, the object database 104-A.

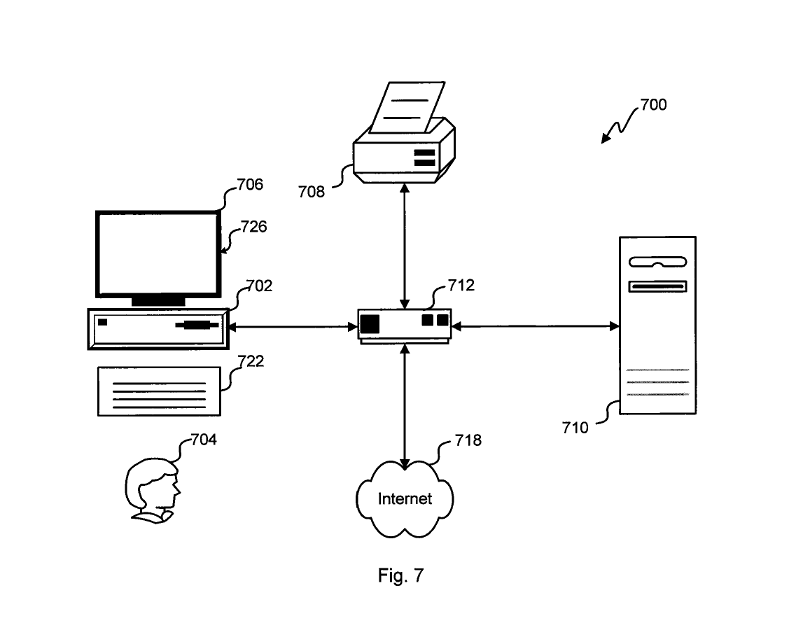

With reference now to FIG. 7, an exemplary environment with which embodiments may be implemented is shown with a computer system 700 that can be used by a user 704 as all or a component of the learning system 100. The computer system 700 can include a computer 702, keyboard 722, a network router 712, a printer 708, and a monitor 706. The monitor 706, processor 702 and keyboard 722 are part of a computer system 726, which can be a laptop computer, desktop computer, handheld computer, mainframe computer, etc. The monitor 706 can be a CRT, flat screen, etc.

A user 704 can input commands into the computer 702 using various input devices, such as a mouse, keyboard 722, track ball, touch screen, etc. If the computer system 700 comprises a mainframe, a designer 704 can access the computer 702 using, for example, a terminal or terminal interface. Additionally, the computer system 726 may be connected to a printer 708 and a server 710 using a network router 712, which may connect to the Internet 718 or a WAN.

The server 710 may, for example, be used to store additional software programs and data. In one embodiment, software implementing the systems and methods described herein can be stored on a storage medium in the server 710. Thus, the software can be run from the storage medium in the server 710. In another embodiment, software implementing the systems and methods described herein can be stored on a storage medium in the computer 702. Thus, the software can be run from the storage medium in the computer system 726. Therefore, in this embodiment, the software can be used whether or not computer 702 is connected to network router 712. Printer 708 may be connected directly to computer 702, in which case, the computer system 726 can print whether or not it is connected to network router 712.

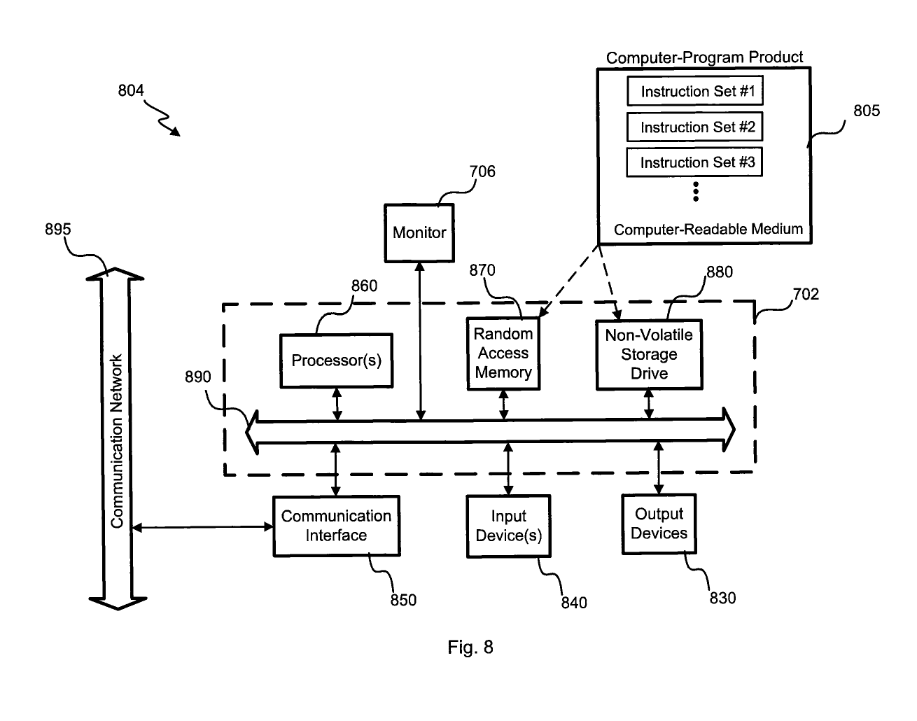

With reference to FIG. 8, an embodiment of a special-purpose computer system 804 is shown. The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system 726, it is transformed into the special-purpose computer system 804.

Special-purpose computer system 804 comprises a computer 702, a monitor 706 coupled to computer 702, one or more additional user output devices 830 (optional) coupled to computer 702, one or more user input devices 840 (e.g., keyboard, mouse, track ball, touch screen) coupled to computer 702, an optional communications interface 850 coupled to computer 702, a computer-program product 805 stored in a tangible computer-readable memory in computer 702. Computer-program product 805 directs system 804 to perform the above-described methods. Computer 702 may include one or more processors 860 that communicate with a number of peripheral devices via a bus subsystem 890. These peripheral devices may include user output device(s) 830, user input device(s) 840, communications interface 850, and a storage subsystem, such as random access memory (RAM) 870 and non-volatile storage drive 880 (e.g., disk drive, optical drive, solid state drive), which are forms of tangible computer-readable memory.

Computer-program product 805 may be stored in non-volatile storage drive 880 or another computer-readable medium accessible to computer 702 and loaded into memory 870. Each processor 860 may comprise a microprocessor, such as a microprocessor from Intel® or Advanced Micro Devices, Inc.®, or the like. To support computer-program product 805, the computer 702 runs an operating system that handles the communications of product 805 with the above-noted components, as well as the communications between the above-noted components in support of the computer-program product 805. Exemplary operating systems include Windows® or the like from Microsoft® Corporation, Solaris® from Oracle®, LINUX, UNIX, and the like.

User input devices 840 include all possible types of devices and mechanisms to input information to computer system 702. These may include a keyboard, a keypad, a mouse, a scanner, a digital drawing pad, a touch screen incorporated into the display, audio input devices such as voice recognition systems, microphones, and other types of input devices. In various embodiments, user input devices 840 are typically embodied as a computer mouse, a trackball, a track pad, a joystick, wireless remote, a drawing tablet, a voice command system. User input devices 840 typically allow a user to select objects, icons, text and the like that appear on the monitor 706 via a command such as a click of a button or the like. User output devices 830 include all possible types of devices and mechanisms to output information from computer 702. These may include a display (e.g., monitor 706), printers, non-visual displays such as audio output devices, etc.

Communications interface 850 provides an interface to other communication networks 895 and devices and may serve as an interface to receive data from and transmit data to other systems, WANs and/or the Internet 718. Embodiments of communications interface 850 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 850 may be coupled to a computer network, to a FireWire® bus, or the like. In other embodiments, communications interface 850 may be physically integrated on the motherboard of computer 702, and/or may be a software program, or the like.

RAM 870 and non-volatile storage drive 880 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 870 and non-volatile storage drive 880 may be configured to store the basic programming and data constructs that provide the functionality of various embodiments of the present invention, as described above.

Software instruction sets that provide the functionality of the present invention may be stored in RAM 870 and non-volatile storage drive 880. These instruction sets or code may be executed by the processor(s) 860. RAM 870 and non-volatile storage drive 880 may also provide a repository to store data and data structures used in accordance with the present invention. RAM 870 and non-volatile storage drive 880 may include a number of memories including a main random access memory (RAM) to store of instructions and data during program execution and a read-only memory (ROM) in which fixed instructions are stored. RAM 870 and non-volatile storage drive 880 may include a file storage subsystem providing persistent (non-volatile) storage of program and/or data files. RAM 870 and non-volatile storage drive 880 may also include removable storage systems, such as removable flash memory.

Bus subsystem 890 provides a mechanism to allow the various components and subsystems of computer 702 communicate with each other as intended. Although bus subsystem 890 is shown schematically as a single bus, alternative embodiments of the bus subsystem may utilize multiple busses or communication paths within the computer 702.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

1. A method of adding a learning object to a multi-dimensional network, the method comprising:
identifying a first learning object comprising an aggregation of learning content associated with an assessment, wherein the first learning object is connected within a learning object network based on a common subject of the learning object network;
retrieving information associated with the first learning object, wherein the information associated with the first learning object identifies an aspect of the first learning object;
identifying a non-subject skill level of the first learning object, wherein the non-subject skill level identifies a skill that is independent of the common subject of the learning object network, wherein the non-subject skill level is an indicator of the non-subject difficulty of the content of the first learning object;
adding a value indicative of the non-subject skill value of the first learning object;
identifying a second learning object comprising an aggregation of learning content associated with an assessment and a non-subject skill level lower than the non-subject skill level of the first learning object, wherein the learning content of the second learning object is independent of the common subject of the learning object network;
identifying a third learning object comprising a non-subject skill level higher than the non-subject skill level of the first learning object; and
generating a second learning vector based on the identified non-subject skill levels of the first and second learning objects, wherein the second learning vector extends from the second learning object to the first learning object, and generating a third learning vector based on the identified non-subject skill levels of the first and third learning objects, wherein the third learning vector extends from the first learning object to the third learning object.

2. The method of claim 1, wherein the non-subject skill level comprises at least one of a quantile level and a lexile level.

3. The method of claim 1, wherein the aggregation of learning content comprises a plurality of content objects and an assessment.

4. The method of claim 3, wherein identifying the non-subject skill level of the first learning object comprises determining if the first learning object has a corresponding non-subject skill level identified in the information associated with the first learning object.

5. The method of claim 4, wherein identifying the non-subject skill level of the first learning object comprises determining a skill level of the first learning object if a non-subject skill level is not identified in the information associated with the first learning object.

6. The method of claim 5, wherein the non-subject skill level is determined by analyzing the aggregation of learning content of the learning object.

7. The method of claim 6, wherein one of the content objects or the assessment is analyzed.

8. The method of claim 1, further comprising determining a subject matter of the first learning object.

9. The method of claim 8, wherein determining the subject matter of the first learning object comprises extracting information identifying the subject matter of the first learning object from the information associated with the first learning object.

10. The method of claim 1, wherein at least one of the second and third learning objects comprise the same subject matter as the first learning object.

11. A system for maintaining a multi-dimensional network, the system comprising:
memory comprising:
a plurality of learning objects comprising an aggregation of learning content associated with an assessment;
information associated with the learning objects, wherein the information identifies an aspect of the therewith associated learning object;
a processor configured to:
identify a first learning object, wherein the first learning object is connected within a learning object network based on a common subject of the learning object network;
identify a non-subject skill level of the first learning object, wherein the non-subject skill level identifies a skill that is independent of the common subject of the learning object network, wherein the non-subject skill level is an indicator of the non-subject difficulty of the content of the first learning object;
add a value indicative of the non-subject skill value of the first learning object;
identify a second learning object comprising a non-subject skill level lower than the non-subject skill level of the first learning object, wherein the learning content of the second learning object is independent of the common subject of the learning object network;
identify a third learning object comprising a non-subject skill level higher than the non-subject skill level of the first learning object; and
generate second learning vector based on the identified non-subject skill levels of the first and second learning objects, wherein the second learning vector extends from the second learning object to the first learning object and generating a third learning vector based on the identified non-subject skill levels of the first and third learning objects, wherein the third learning vector extends from the first learning object to the third learning object.

12. The system of claim 11, wherein the processor is further configured to retrieve information associated with the first learning object, which information identifies an aspect of the first learning object.

13. The system of claim 11, wherein the non-subject skill level comprises at least one of a quantile level and a lexile level.

14. The system of claim 11, wherein the aggregation of learning content comprises a plurality of content objects.

15. A method of generating a multidimensional learning object network comprising:
identifying a first learning object comprising a plurality of content objects, wherein the content objects are associated with an assessment, and wherein the content object comprise groupings of learning content;
selecting a content object from the plurality of content objects;
selecting a desired skill level determination, wherein the desired skill level determination comprises a determination of a skill-related degree of difficulty of the learning content of the content object;
determining the skill level of the learning content of the content object;
retrieving assessment information associated with an assessment, wherein the assessment information identifies a skill evaluated by the assessment and the skill level evaluated by the assessment;
determining if the assessment matches the learning content of the content object; and
generating a learning vector connecting the content object and the assessment if the skill evaluated by the assessment and the skill level evaluated by the assessment match the determined skill and the determined skill level of the content object.

16. The method of claim 15, wherein determining if the assessment matches the learning content of the content object comprises:
determining if the skill evaluated by the assessment matches the skill of the determined skill level of the learning content of the content object.

17. The method of claim 16, wherein determining if the assessment matches the learning content of the content object comprises determining if the skill level evaluated by the assessment matches the determined skill level of the learning content of the content object.

18. The method of claim 15, wherein determining the skill level of the learning content of the content object comprises retrieving data associated with the content object and identifying the skill level of the learning content of the content object.

19. The method of claim 15, wherein determining the skill level of the learning content of the content object comprises evaluating the learning content of the content object for skill level indicators.

20. The method of claim 18, wherein the skill level indicators comprise at least one of:
vocabulary; and
mathematical symbols.
